(19) United States
(12) Patent Application Publication
(10) Pub. No.: US 2009/0042090 A1
(43) Pub. Date: Feb. 12, 2009

(54) FUEL CELL

(76) Inventors: Nobuyasu Negishi, Kanagawa-ken (JP); Jun Momma, Kanagawa-ken (JP); Yumiko Takizawa, Kanagawa-ken (JP); Yukinori Akamoto, Chiba-ken (JP); Yuuichi Sato, Tokyo (JP); Genta Oomichi, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/088,199

(22) PCT Filed: Sep. 25, 2006
(86) PCT No.: PCT/JP2006/318958

§ 371 Date: Mar. 26, 2008

(30) Foreign Application Priority Data
Sep. 29, 2005 (JP) 2005-284969

(51) Int. Cl. H01M 8/00

(52) U.S. Cl. 429/40

(57) ABSTRACT

The present invention provides a fuel cell comprising: a cathode catalyst layer 2; an anode catalyst layer 3; a proton conductive membrane 6 disposed between the cathode catalyst layer 2 and the anode catalyst layer 3; a liquid fuel tank 9 for storing a liquid fuel L; a fuel vaporizing layer 10 for supplying a vaporized component of the liquid fuel L to the anode catalyst layer 3; a surface layer 15 having an air intake port 14 for supplying an air to the cathode catalyst layer 2; and a moisture retention plate 13A, disposed between the surface layer 15 and the cathode catalyst layer 2, for preventing water generated at the cathode catalyst layer from being evaporated, wherein the moisture retention plate is composed of a laminated body comprising at least two kind of porous members 13a and 13b each having different moisture permeability (moisture retention property). According to the above structure, the water content generated at the cathode catalyst layer can be properly released as battery reaction is advances, and a part of the water content can be flown back to the anode catalyst layer side whereby cell output characteristics can be improved.

### TECHNICAL FIELD

The present invention relates to a fuel cell (fuel battery) having a system in which a vaporized fuel obtained by vaporizing a liquid fuel is supplied to an anode catalyst layer. More particularly, the present invention relates to a fuel cell capable of properly releasing water content generated at a cathode catalyst layer as battery reaction is advances, and capable of flowing back a part of the water content to an anode catalyst layer side whereby cell output characteristics can be improved.

### BACKGROUND ART

In recent years, various electronic devices such as personal computer, cellular phone or the like have been manufactured to be miniature in size in accordance with a remarkable development of semiconductor technique, and a fuel cell has been tried to be adopted as a power source for these small-sized electronic devices. The fuel cell has advantages such that it can generate an electrical power by only being supplied with the fuel and the oxidizing reagent, and the power generating operation can be continuously performed as far as only the fuel is substantially supplied to the cell. Due to above advantages, when the miniaturization or downsizing of the fuel cell is realized, it can be said that the fuel cell becomes a really advantageous system as an operating power source for the portable electronic devices.

In particular, a direct methanol fuel cell (DMFC) uses methanol having a high energy density as the fuel, and can directly extract a current from methanol at an electrode catalyst. Therefore, the fuel cell can be formed in a compact size, and a handling of the fuel is safe and easy in comparison with a cell using hydrogen gas as fuel, so that the direct methanol fuel cell has been intensely expected as a power source for the compact electronic devices.

As a method of supplying the fuel into DMFC, the following types have been adopted. Namely, there are: a gas-fuel supplying type DMFC in which a liquid fuel is vaporized and the vaporized fuel gas is then supplied into the fuel cell by means of a blower or the like; a liquid-fuel supplying type DMFC in which a liquid fuel is supplied, as it is, into the fuel cell by means of a liquid pump or the like; and an internal-vaporizing type DMFC as disclosed in a patent document 1 (Japanese Patent No. 3413111).

The internal-vaporizing type DMFC shown in the patent document 1 comprises: a fuel penetrating layer for retaining the liquid fuel; and a fuel vaporizing layer for vaporizing the liquid fuel and diffusing a vaporized component of the liquid fuel retained in the fuel penetrating layer, so that the vapor of the liquid fuel is supplied from the fuel vaporizing layer to a fuel pole (anode). In the fuel cell disclosed in the patent document 1, there is used a methanol aqueous solution as the liquid fuel prepared by mixing methanol with water at a molar ratio of about 1:1, and both the methanol and water in a form of a vaporized gas mixture is supplied to the fuel pole.

According to the conventional internal-vaporizing type DMFC shown in the patent document 1, a sufficiently high cell output characteristic could not be obtained. Concretely, a vapor pressure of water is relatively lower than that of methanol, and a vaporization rate of water is relatively slow in comparison with that of methanol. Therefore, when the methanol together with water are tried to be supplied to the fuel pole, a supplying amount of water with respect to that of methanol becomes relatively deficient. As a result, a resistance of a reaction for internal reforming of methanol is disadvantageously increased, so that the sufficiently high output power characteristic could not be obtained.

Patent Document 1: Patent Gazette of Japanese Patent No. 3413111

In order to cope with the above problem such that the relative supplying amount of water with respect to that of methanol is deficient, there has been tried to adopt a structure in which a moisture retention plate composed of porous plate or the like for preventing the water from being evaporated is laminated onto an upper portion side of the cathode conductive layer. According to this moisture retention structure, it has been expected to prevent the evaporation of water generated at the cathode catalyst layer toward outside the cell, while to flow back an excess water to the anode catalyst layer thereby to secure a sufficient water required for conducting the internal reforming reaction of methanol.

However, it is extremely difficult to properly control the amount of water to be evaporated to outside the cell and the amount of water to be flown back to the anode catalyst layer. Therefore, there is posed a tendency that a large amount of water retained in the above moisture retention plate having certain moisture absorbing property is flown back at an amount more than necessary. As a result, there has been posed a problem that a sufficient output characteristic of the cell cannot be obtained.

That is, when an excess amount water is flown back to the fuel tank, the water obstructs the evaporation of the fuel, or the water forms water barrier at various portions in the cell, so that a transfer of the fuel to be evaporated and transferred from the fuel tank side to the anode catalyst layer side are disadvantageously obstructed. For these reasons, at any rate, there has been posed the problem that the fuel supply becomes insufficient, thereby to lower the output characteristic of the cell.

### DISCLOSURE OF THE INVENTION

The present invention has been achieved to solve the above conventional problems, and an object of the present invention is to stabilize and improve the output characteristic of the small-sized fuel cell having a system in which a vaporized fuel obtained by vaporizing a liquid fuel is supplied to an anode catalyst layer. Particularly, the object of the present invention is to provide a fuel cell capable of properly releasing water content generated at a cathode catalyst layer as battery reaction is advances, and capable of flowing back a part of the water content to an anode catalyst layer side whereby cell output characteristics can be improved.

To achieve the above object, the inventors of the present invention had searched various mechanisms capable of properly controlling a water amount releasing to outside the cell and a water amount flowing back to the anode catalyst layer, among the water contents generated from the cathode catalyst layer as the battery reaction is advances. As a result, when a moisture retention layer composed of a laminated body comprising at least two kind of porous members each having different moisture permeability (moisture retention property) was formed in place of the conventional moisture retention layer composed of a single substance layer, it was confirmed that the water amount to be released to outside the cell and the water amount to be flown back to the anode catalyst layer could be properly controlled, whereby the cell output characteristics could be improved. The present invention had been achieved on the basis of the above findings.

That is, the present invention provides a fuel cell comprising: a cathode catalyst layer; an anode catalyst layer; a proton conductive membrane disposed between the cathode catalyst layer and the anode catalyst layer; a liquid fuel tank for storing a liquid fuel; a fuel vaporizing layer for supplying a vaporized component of the liquid fuel to the anode catalyst layer; a surface layer having an air intake port for supplying an air to the cathode catalyst layer; and a moisture retention plate, disposed between the surface layer and the cathode catalyst layer, for preventing water generated at the cathode catalyst layer from being evaporated, wherein the moisture retention plate is composed of a laminated body comprising at least two kind of porous members each having different moisture permeability (moisture retention property).

According to the above fuel cell, in the porous member having relatively low moisture permeability, the moisture content is hardly penetrated through the porous member. Hence, the porous member becomes rich in moisture retention property, so that the porous member is held in a moist state. The water content is vaporized from the porous member in moist state, and the vaporized water content passes through the surface layer and released to outside of the cell. On the other hand, in the porous member having relatively high moisture permeability, the moisture content is easily penetrated through the porous member. Hence, the porous member becomes rich in water-shedding property, so that moisture content in the porous member is held in a low state. Therefore, among the water contents generated at the cathode catalyst layer when the cell reaction advances, the water content absorbed in the porous member having a low moisture permeability is sequentially evaporated and released to the outside the fuel cell through the surface layer.

On the other hand, the water content once absorbed in the porous member having high moisture permeability is flown back and returned to the anode catalyst layer side. As a result, a water amount required for the reforming reaction of the fuel at the anode catalyst layer is secured at all times, and there is no case where the water amount is deficient. Accordingly, the cell output can be maintained to be stable and high level at all times.

In this connection, the above moisture permeability of the porous member is defined as a value obtained in such a manner that a moisture weight (g) penetrated through the porous member under a predetermined temperature and humidity atmosphere is measured and then the measured moisture weight is divided by an area of the porous member and a penetrating time thereby to converted into a value (penetrated moisture weight value) per unit area (1 m²) and unit time (24 hours).

Concretely, the moisture permeability is a value measured in accordance with A-1 method in which calcium chloride is used as a moisture-absorption agent. The A-1 method is defined by “Moisture Permeability Testing Method for Textile Product” which is prescribed in Japanese Industrial Standard (JIS L1099-1993).

In the above moisture permeability testing method (A-1), measuring operation is performed as the following steps as shown in FIG. 2. Namely, calcium chloride as an absorbing agent 21 is filled in an aluminum-made cup 20 having an inner diameter of 60 mm. The porous member is cut out as a test sample having a diameter of 70 mm. The test sample of the porous member 13 is attached to an opening of the cup 20 by interposing a ring member 22 therebetween, and fastened by butterfly nuts 23 thereby to fix the test sample. Thereafter, an attaching side surface of the opening is sealed by a vinyl adhesive tape 24 thereby to prepare a testing body. Then, the testing body is disposed on a position in a constant-temperature and humidity chamber in which temperature is controlled to be 40×2° C. and a relative humidity of atmosphere is set to (90±5)% RH. A wind velocity at 1 cm above the test sample is limited so as not to exceed 0.8 m/S.

After one hour later, the testing body is take out from the chamber and followed by immediately measuring a mass (a1) of the testing body in a measuring unit of 1 mg. After the measuring, the testing body is again disposed onto the same position in the constant-temperature and humidity chamber. After 24 hours later, the testing body is take out and followed by immediately measuring a mass (a2) of the testing body in the measuring unit of 1 mg. Thereafter, the moisture permeability of the testing body is calculated in accordance with an equation (1). In the present invention, the moisture permeability is expressed by an average value of the measuring results obtained by three-times testing operations.

[Equation 1]

P_{A}=[10×(a2−a1)]/S_{A} (1)

wherein P_{A} is a moisture permeability (g/m²·24 h), (a2−a1) is an amount of change (mg/24 h) in mass of the testing body per 24 hours, and S_{A} is a moisture permeable area (cm²) of the testing body.

Further, in the above fuel cell, it is preferable to configure the fuel cell such that the porous member constituting the moisture retention plate and having a relatively high moisture permeability is disposed to a side of the cathode catalyst layer.

When the porous member having the relatively high moisture permeability (moisture retention property) is disposed to a portion close to the cathode catalyst layer, a part of the water generated from the cathode catalyst member as the cell reaction advances is effectively flown back and returned to the anode catalyst layer side. On the other hand, a releasing of water evaporated from the porous member having a low moisture permeability (moisture retention property) through the surface layer is not substantially obstructed, so that a lowering of the cell output due to excess and deficiency of water can be effectively prevented.

Furthermore, in the above fuel cell, as the porous member constituting the aforementioned moisture retention plate, a laminated body in which a plurality of porous members is laminated is used. However, it is preferable that each of the respective porous members is a fiber type porous member or a foamed type porous member.

In case of the fiber type porous member, when knitting structure or braiding density of the fibers is changed, the porous members having various moisture permeability can be prepared. While, in case of the foamed type porous member, when a foaming density of a resin material is changed, the porous members having various moisture permeability can be also prepared.

As a concrete example of the porous member, there can be suitably used a hydrophilic urethane (moisture permeability:15000 g/m²·24 h), PTFE (moisture permeability:30000 g/m²·24 h), ordinary urethane (moisture permeability:5000 g/m²·24 h), foamed poly ethylene (moisture permeability:4000 g/m²24 h) or the like.

A thickness of the respective porous members varies in accordance with the moisture permeability or water-retention capacity of the porous members. However, a water amount generated by an oxidation reaction occurred at the cathode catalyst layer is about three-times larger than the water amount required for performing the reforming reaction for reforming the fuel in the anode catalyst layer.

Therefore, it is preferable that the thickness of the porous member having a small moisture permeability and a high moisture retention property is set so as to have a thickness capable of retaining about two-fold amount of water, while the thickness of the porous member having a larger moisture permeability and a high water-shedding property is set so as to have a thickness capable of flowing back one-fold amount of water to anode catalyst layer side.

Concretely to say, it is preferable that the thickness of the laminate of porous members each having a different moisture permeability is set to 100 to 1000 μm, the thickness of the porous member having a small moisture permeability and a high moisture retention property is set to be double the thickness of the porous member having a larger moisture permeability and a high water-shedding property.

Furthermore, in the above fuel cell, it is also preferable that at least one sheet of porous member is disposed between the liquid fuel tank and the fuel vaporizing layer. As the same as in the aforementioned moisture retention layer, this porous member is also formed of the fiber type porous member or the foamed type porous member.

When the porous member is disposed between the liquid fuel tank and the fuel vaporizing layer as described above, the liquid fuel stored in the liquid fuel tank and the vaporized fuel supplied from the fuel tank are effectively separated at the porous member. As a result, there can be prevented, so called “crossover phenomenon” in which a highly concentrated fuel is supplied in a state of liquid to the anode catalyst layer and the cathode catalyst layer, thereby to prevent the lowering of the cell output.

### EFFECT OF THE INVENTION

According to the above fuel cell of the present invention, in the porous member having low moisture permeability, the moisture content is hardly penetrated through the porous member. Hence, the porous member becomes rich in moisture retention property, so that the porous member is held in a moist state. The water content is vaporized from the porous member in moist state, and the vaporized water content passes through the surface layer and released to outside of the cell. On the other hand, in the porous member having relatively high moisture permeability, the moisture content is easily penetrated through the porous member. Hence, the porous member becomes rich in water-shedding property, so that moisture content in the porous member is held in a low state. Therefore, among the water contents generated at the cathode catalyst layer when the cell reaction advances, the water content absorbed in the porous member having a low moisture permeability is sequentially evaporated and released to the outside the fuel cell through the surface layer.

On the other hand, the water content once absorbed in the porous member having high moisture permeability is flown back and returned to the anode catalyst layer side. As a result, a water amount required for the reforming reaction of the fuel at the anode catalyst layer is secured at all times, and there is no case where the water amount is deficient. Accordingly, the cell output can be maintained to be stable and high level at all times.

### BEST MODE FOR CARRYING OUT THE INVENTION

The inventors of this invention had conducted eager researches and developments about a structure capable of improving cell characteristics of a fuel cell having a system in which a vaporized fuel obtained by vaporizing a liquid fuel is supplied to an anode catalyst layer. As a result, the following technical knowledge and findings were obtained for the fuel cell. Namely, when a moisture retention layer composed of a laminated body comprising at least two kind of porous members each having different moisture permeability (moisture retention property) was formed, it was confirmed that the water amount to be released to outside the cell and the water amount to be flown back to the anode catalyst layer could be properly controlled, whereby there could be obtained a fuel cell having a stable output characteristics and capable of preventing a lowering of the cell output characteristics due to excess and deficiency of water.

In particular, the inventors had found that when about one-thirds of the water generated at the cathode catalyst layer was supplied to the anode catalyst layer through the proton conductive membrane by the action of water-flowing-back function of the porous member having a high moisture permeability, the internal reforming reaction of the fuel can be smoothly advanced, thereby to improve the output characteristics of the cell.

Further, the inventors had found that when the water generated at the cathode catalyst layer was retained in the porous member having small moisture permeability and there was created a state where a water retention amount at the cathode catalyst layer is larger than that of the anode catalyst layer, a diffusion reaction of the generated water for diffusing from the cathode catalyst layer to the anode catalyst layer through the proton conductive membrane could be promoted. Therefore, it became possible to improve a water supplying rate in comparison with a case where the water supplying rate depended on only the fuel vaporizing layer, so that a reaction resistance of the internal reforming reaction of the fuel could be lowered, whereby the output characteristics of the cell could be improved.

Furthermore, a part of the water generated at the cathode catalyst layer can be steadily utilized at anode catalyst layer for performing the internal reforming reaction of the liquid fuel, so that a process of discharging the water generated at the cathode catalyst layer to outside the fuel cell or the like can be alleviated. In addition, there is no need to provide a special structure for supplying the water to the liquid fuel, so that a fuel cell having a simple structure can be provided.

Further, according to the fuel cell of the present invention, there can be used a highly concentrated fuels such as pure methanol or the like having an excessive stoichiometric ratio. Conventionally, such a highly concentrated fuel cannot have been used theoretically.

Hereunder, a direct methanol type fuel cell as one embodiment of the fuel cell according to the present invention will be explained and illustrated in more detail with reference to the attached drawings.

At first, a first embodiment will be explained. FIG. 1 is a sectional view schematically showing a structure of the first embodiment of the direct methanol type fuel cell according to the present invention.

As shown in FIG. 1, the membrane electrode assembly (MEA) 1 is configured by comprising: a cathode pole having a cathode catalyst layer 2 and a cathode gas diffusing layer 4; an anode pole having an anode catalyst layer 3 and an anode gas diffusing layer 5; and a proton conductive electrolyte membrane 6 provided at a portion between the cathode catalyst layer 2 and the anode catalyst layer 3.

Examples of a catalyst contained in the cathode catalyst layer 2 and the anode catalyst layer 3 may include: for example, a single substance metal (Pt, Ru, Rh, Ir, Os, Pd or the like) of the platinum group elements; and alloys containing the platinum group elements. As a material for constituting the anode catalyst, Pt—Ru alloy is preferably used because it has a high resistance to methanol and carbon monoxide. While, as a material for constituting the cathode catalyst, platinum (Pt) is preferably used. However, the materials are not limited thereto. In addition, it is possible to use a support type catalyst using electrically conductive carrier formed of carbon material or the like, and it is also possible to use a non-carrier catalyst.

In addition, examples of a proton conductive material for constituting the proton conductive electrolyte membrane 6 may include: for example, fluoric type resin, such as perfluoro-sulfonic acid, having a sulfonic acid group; hydrocarbon type resin having a sulfonic acid group; and inorganic substances such as tungstic acid, phosphotungstic acid or the like. However, the proton conductive material is not limited thereto.

The cathode gas diffusing layer 4 is laminated onto an upper surface side of the cathode catalyst layer 2, while the anode gas diffusing layer 5 is laminated onto a lower surface side of the anode catalyst layer 3. The cathode gas diffusing layer 4 fulfills a role of uniformly supplying the oxidizing agent to the cathode catalyst layer 2, and also serves as a collector of the cathode catalyst layer 2. On the other hand, the anode gas diffusing layer 5 fulfills a role of uniformly supplying the fuel to the anode catalyst layer 3, and also serves as a collector of the anode catalyst layer 3.

The cathode conductive layer 7a and the anode conductive layer 7b are respectively contacted to the cathode gas diffusing layer 4 and the anode gas diffusing layer 5. As a material for constituting the cathode conductive layer 7a and the anode conductive layer 7b, for example, a porous layer (for example, mesh member) or foil member composed of a metal material such as gold or the like can be used.

A cathode seal member 8a having a rectangular frame shape is positioned at a portion between the cathode conductive layer 7a and the proton conductive electrolyte membrane 6. Simultaneously, the cathode seal member 8a air-tightly surrounds circumferences of the cathode catalyst layer 2 and the cathode gas diffusing layer 4.

On the other hand, an anode seal member 8b having a rectangular frame shape is positioned at a portion between the anode conductive layer 7b and the proton conductive electrolyte membrane 6. Simultaneously, the anode seal member 8b air-tightly surrounds circumferences of the anode catalyst layer 3 and the anode gas diffusing layer 5. The cathode seal member 8a and the anode seal member 8b are O-rings for preventing the fuel and the oxidizing agent from leaking from the membrane electrode assembly 1.

Under the membrane electrode assembly 1 is provided with a liquid fuel tank 9. In the liquid fuel tank 9, a liquid fuel L such as a liquid methanol, a methanol aqueous solution or the like are accommodated. At an opening end portion of the liquid fuel tank 9 is provided with a gas-liquid separating membrane 10 as a fuel vaporizing layer 10 so that the gas-liquid separating membrane 10 covers the opening end portion of the liquid fuel tank 9. The gas-liquid separating membrane 10 allows only the vaporized component of the liquid fuel to pass therethrough, and not allow the liquid fuel to pass therethrough.

In this connection, the vaporized component of the liquid fuel means a vaporized methanol in a case where the liquid methanol is used as the liquid fuel, while the vaporized component of the liquid fuel means a mixture gas comprising a vaporized component of methanol and a vaporized component of water in a case where the methanol aqueous solution is used as the liquid fuel.

In this regard, the liquid fuel to be stored in the liquid fuel tank 9 is not always limited to methanol fuel. For example, ethanol fuels such as ethanol aqueous solution, pure ethanol or the like, dimethyl ether, formic acid or other liquid fuels can be also used. At any rate, a liquid fuel in compliance with a fuel cell is suitably used, and accommodated (injected) into the liquid fuel tank 9.

A frame 11 composed of resin is laminated to a portion between the gas-liquid separating membrane 10 and the anode conductive layer 7b. A space enclosed by the frame 11 functions as the vaporized fuel chamber 12 (so called, a vapor retaining pool) for temporally storing the vaporized fuel diffused from the gas-liquid separating membrane 10. Due to an effect of suppressing an amount of methanol passing through the vaporized fuel chamber 12 and the gas-liquid separating membrane 10, it becomes possible to avoid a situation where a large amount of the vaporized fuel is supplied to the anode catalyst layer 3 at a time, so that an occurrence of “methanol crossover” can be effectively suppressed. In this regard, the frame 11 may be formed to have a rectangular shape, and may be formed of thermoplastic polyester resin such as PET (polyethylene terephthalate) or the like.

On the other hand, on the cathode conductive layer 7a laminated on an upper portion of the membrane electrode assembly 1 is laminated with a moisture retention plate 13A. This moisture retention plate 13A is configured by a laminated body comprising two kinds of porous members 13a, 13b each having different moisture permeability (moisture retaining property). Concretely, the moisture retention plate 13A is configured by the laminated body comprising: a porous member 13a composed of hydrophilic foamed urethane (moisture permeability:15000 g/m²·24 h) and a porous member 13b composed of foamed poly ethylene (moisture permeability:4000 g/m²·24 h). Further, the porous member 13b having high moisture permeability (high moisture retention property) is provided to a side of the cathode catalyst layer 2.

The porous member 13a constituting the above moisture retention plate 13A, and having a relatively small moisture permeability, performs a role in absorbing and retaining the water generated at the cathode catalyst layer 2 and a role in suppressing an evaporation of the water, and also performs a role as an auxiliary diffusing layer for promoting a uniform diffusion of the oxidizing agent to the cathode catalyst layer 2 by uniformly introducing the oxidizing agent to the cathode gas diffusing layer 4.

On the other hand, the porous member 13b having large moisture permeability and high water-shedding property, which constitutes the moisture retention plate 13A, performs a role in supplying about one-thirds amount of water generated at the cathode catalyst layer 2 to the anode catalyst layer 3 through the proton conductive membrane 6.

Further, on the moisture retention plate 13A is laminated with a surface layer 15 formed with a plurality of air-intake ports 14 for introducing air as oxidizing agent. The surface layer 15 performs also a role in increasing a close-contacting property of a stack including the membrane electrode assembly 1 by pressing the stack including the membrane electrode assembly 1, so that the surface layer 15 is formed of metal such as SUS304 or the like.

According to the first embodiment of the direct methanol type fuel cell having the structure described above, the liquid fuel (for example, methanol aqueous solution) stored in the liquid fuel tank 9 is vaporized, the vaporized methanol and water are diffused through a gas/liquid separating film (fuel vaporizing layer) 10 and once accommodated within an upper space (vaporized fuel accommodating chamber 12) of the fuel tank 9. Then, the vaporized methanol and water gradually diffuse in the anode gas diffusing layer 5 thereby to be supplied to the anode catalyst layer 3. As a result, an internal reforming reaction of methanol is taken place in accordance with the following reaction formula (2).

CH₃OH+H₂O→CO₂+6H⁺+6e⁻ (2)

Further, in a case where a pure methanol is used as the liquid fuel, there is no water supplied from the fuel vaporizing layer, so that the water generated by the oxidation reaction of the methanol mixed in the cathode catalyst layer 2 or a moisture content or the like in the proton conductive electrolyte membrane 6 reacts with methanol. As a result, the internal reforming reaction in accordance with the reaction formula (2) is taken place, or the internal reforming reaction not depending on the aforementioned reaction formula (2) is taken place in a reaction mechanism without using the water.

The carbon dioxide gas (CO₂ gas) is generated at the anode catalyst layer 3 by a decomposing reaction of the fuel such as methanol or the like. The generated carbon dioxide gas is supplied to the vaporized fuel chamber 12 formed between the fuel vaporizing layer 10 and the anode catalyst layer 3. The vaporized fuel chamber 12 is provided with an exhaust path (not shown), so that the generated carbon dioxide gas can be exhausted through this exhaust path.

The proton (H⁺) generated by the above internal reforming reaction diffuses in the proton conductive electrolyte membrane 6, and then arrives at the cathode catalyst layer 3. On the other hand, the air introduced from the air intake port 14 of the surface layer 15 diffuses in both the moisture retaining plate 13A and the cathode gas diffusing layer 4 thereby to be supplied to the cathode catalyst layer 2. In the cathode catalyst layer 2, a reaction shown in the following reaction formula (3) is taken place thereby to generate water. Namely, a power generating reaction is taken place.

(3/2)O₂+6H⁺+6e⁻→3H₂O (3)

When the power generating reaction is advanced, the water generated in the cathode catalyst layer 2 in accordance with the reaction formula (3) diffuses in the cathode gas diffusing layer 4, and arrives at the moisture retaining plate 13A. Most of the water is absorbed in the porous member 13a having a small moisture permeability, and an evaporation of the water is inhibited by the moisture retaining plate 13A thereby to increase a water storing amount in the cathode catalyst layer 2.

On the other hand, a part of the water absorbed in the porous member 13b having a large moisture permeability and a high water-shedding property is passed through the proton conductive membrane 6 due to the water-shedding function of the porous member 13b, thereby to be flown back to the anode catalyst layer 3.

Therefore, in accordance with an advancement of the power generating reaction, there can be realized a state where the moisture retaining amount of the cathode catalyst layer 2 is larger than that of the anode catalyst layer 3.

As a result, due to an osmotic-pressure phenomena, it becomes possible to effectively promote a diffusion reaction for transferring (diffusing) the water generated at the cathode catalyst layer 2 to the anode catalyst layer 3 through the proton conductive electrolyte membrane 6. Therefore, a water-supplying rate to the anode catalyst layer 3 can be increased in comparison with a case where the water-supplying rate depends on only the fuel vaporizing layer, and the internal reforming reaction shown in the reaction formula (2) can be promoted. Therefore, an output power density can be increased and it becomes possible to maintain such the high output power density for a long time period.

Further, when a methanol aqueous solution having a concentration exceeding 50 mol % or a pure methanol is used as the liquid fuel, the water returned and diffused from the cathode catalyst layer 2 to the anode catalyst layer 3 is mainly used for the internal reforming reaction due to an water-back-flowing effect of the porous member 13b having the large moisture permeability and the high water-shedding property.

Accordingly, an operation for supplying the water to the anode catalyst layer 3 can be stably advanced whereby the reaction resistance of the internal reforming reaction can be further decreased and a long-term output power characteristic and a load current characteristic of the fuel cell can be further improved. In addition, it is also possible to miniaturize a size of the liquid fuel tank 9. In this connection, a purity of the pure methanol is preferably set to a range from 95 to 100 mass %.

Next, a second embodiment of the direct methanol type fuel cell according to the present invention will be explained and illustrated in more detail with reference to the attached drawings.

This second embodiment of the direct methanol type fuel cell has substantially the same configuration as that of the first embodiment of the direct methanol type fuel cell as described above, except that a porous member 13c composed of the foamed hydrophilic urethane (moisture permeability:15000 g/m²·24 h) is interposed at a portion between the liquid fuel tank 9 and the fuel vaporizing layer 10 as shown in FIG. 3.

In this second embodiment, a methanol aqueous solution having a concentration of 50 mass % or more or a pure methanol (of which purity is preferably set to a range of 95-100 mass %) is used as the liquid fuel to be stored in the liquid fuel tank.

According to this second embodiment configured as above, since the porous member 13c composed of the foamed hydrophilic urethane having a predetermined moisture permeability is interposed at a portion between the liquid fuel tank 9 and the fuel vaporizing layer 10, the following functional effect can be exhibited in addition to the functional effects of the first embodiment. That is, the liquid fuel L and the vaporized fuel stored and supplied to the liquid fuel tank 9 can be effectively separated at the porous member 13c.

As a result, so called a cross-over phenomenon, in which a highly concentrated liquid fuel L in a liquid state is supplied to the anode catalyst layer 3 or the cathode catalyst layer 2, can be effectively prevented, so that it becomes possible to prevent lowering of the cell output and to improve the output power density and the long-term output characteristic.

In this connection, the inventors of the present invention had investigated a relationship between a maximum output power and a thickness of the proton conductive electrolyte membrane of the fuel cell in which a perfluoro-carbon type proton conductive electrolyte membrane was used. As a result, in order to realize a high output power of the fuel cell, it was confirmed that when the thickness of the proton conductive electrolyte membrane 6 was preferably set to 100 μm or less, the maximum output power of the fuel could be increased. The reason why the high output power can be obtained by setting the thickness of the proton conductive electrolyte membrane 6 to 100 μm or less is that it becomes possible to further promote the diffusion of water from the cathode catalyst layer 2 to the anode catalyst layer 3.

In this regard, when the thickness of the proton conductive electrolyte membrane 6 is set to less than 10 μm, there may be posed a fear that a strength of the proton conductive electrolyte membrane 6 is disadvantageously lowered. Therefore, it is preferable to set the thickness of the proton conductive electrolyte membrane 6 to within a range of 10-100 μm, more preferable to set to within a range of 10-80 μm.

The present invention is not particularly limited to the aforementioned respective embodiments, and can be modified as far as the invention adopts a structure in which the water generated at the cathode catalyst layer 2 is supplied to the anode catalyst layer 3 through the proton conductive membrane 6, so that the operation for supplying the water to the anode catalyst layer 3 is promoted and the water-supplying operation is stably performed.

### EXAMPLES

Hereunder, Examples of the present invention will be more concretely explained with reference to the accompanying drawings.

### Example 1

<Preparation of Anode Pole>

Perfluoro-carbon sulfonic acid solution, water and methoxy propanol were added to carbon black supporting anode catalyst (Pt: Ru=1:1), so that a paste in which above the carbon black supporting anode catalyst was dispersed was prepared. Thus prepared paste was coated on a porous carbon paper as an anode gas diffusing layer 5, thereby to prepare an anode pole comprising an anode catalyst layer having a thickness of 450 μm.

<Preparation of Cathode Pole>

Perfluoro-carbon sulfonic acid solution, water and methoxy propanol were added to carbon black supporting cathode catalyst (Pt), so that a paste in which above the carbon black supporting cathode catalyst was dispersed was prepared. Thus prepared paste was coated on a porous carbon paper as a cathode gas diffusing layer, thereby to prepare a cathode pole comprising a cathode catalyst layer having a thickness of 400 μm.

A perfluoro-carbon sulfonic acid membrane 6 (Nafion membrane; manufactured by E. I. Du Pont de Nemours & Co.) having a thickness of 30 μm and a moisture content of 10-20 mass % was provided as a proton conductive electrolyte membrane to a portion between the anode catalyst layer 3 and the cathode catalyst layer 2, thereby to form a laminated body. Then, the laminated body was subjected to a hot pressing operation thereby to prepare a membrane electrode assembly (MEA) 1.

A porous member 13a composed of a foamed hydrophilic urethane (moisture permeability:15000 g/m²·24 h) and a porous member 13b composed of a foamed poly ethylene (moisture permeability:4000 g/m²·24 h) each having a thickness of 600 μm were laminated thereby to prepare a moisture retaining plate 13A.

As a frame for constituting the side wall of the vaporized fuel chamber 12, a frame 11 composed of PET and having a rectangular shape and a thickness of 25 μm was prepared. Further, as a member serving as the gas-liquid separating membrane 10, a silicon rubber (SR) sheet having a thickness of 100 μm was prepared.

Thus prepared the membrane electrode assembly 1, the moisture retaining plate 13, the frame 14 and the gas-liquid separating membrane 10 were used to assemble the internal vaporization type direct methanol fuel cell having an aforementioned structure shown in FIG. 1. At this time, 2 mL of pure methanol having a purity of 99.9 wt % was injected into the liquid fuel tank 9, so that there was assembled an internal vaporization type direct methanol fuel cells according to Example 1.

### Example 2

In addition to the structure of Example 1 shown in FIG. 1, a porous member 13c composed of a foamed hydrophilic urethane (moisture permeability:15000 g/m²·24 h) having a thickness of 100 μm was provided to a portion between the liquid fuel tank 9 and the gas-liquid separating membrane 10, thereby to assemble an internal vaporization type direct methanol fuel cell according to Example 2 as shown in FIG. 3. Namely, the fuel cell of Example 2 has substantially the same structure of that of Example 1 except the porous member 13c.

### Comparative Example

On the other hand, the same manufacturing process as in Example 1 was repeated except that a single-layered moisture retaining plate 13 composed of only a porous member formed of poly ethylene having an air permeability of 2 sec/100 cm³ (JIS P-8117) and a moisture permeability of 4000 g/m²·24h (JIS L-1099 A-1 method) having a thickness of 500 μm was assembled in place of the moisture retaining plate 13A in which two sheets of porous members each having a different moisture permeability as used in the fuel cells of Examples 1 and 2. Namely, the fuel cell of Comparative Example shown in FIG. 5 has substantially the same structure of that of Example 1 or 2 shown in FIG. 1 except the single-layered moisture retaining plate 13.

With respect to the fuel cells according to each of the above Examples 1, 2 and Comparative Example, a power generating operation at a room temperature was performed under a constant load. That is, changes with time of output voltages (relative values) of the fuel cells were continuously measured. The measuring results are shown in FIG. 4. An abscissa axis in FIG. 4 denotes a power generating time, while ordinate axes (vertical axes) denote the cell output voltages (relative values). In this regard, the cell output voltage is expressed as a relative voltage value.

As is clear from the results shown in FIG. 4, according to the above fuel cells of the respective Examples 1 and 2 in which the moisture retaining plate 13A composed of the laminated body comprising two kinds of porous members 13a, 13b each having a different moisture permeability was provided, the moisture content generated from the cathode catalyst layer 2 as an advance of the cell reaction could be appropriately released, while a part of the moisture content could be flown back to a side of the anode catalyst layer 3, whereby it was possible to improve the cell output characteristics.

That is, in the porous member 13a having low moisture permeability, the moisture content is hardly penetrated through the porous member 13a. Hence, the porous member 13a becomes rich in moisture retention property, so that the porous member 13a is held in a moist state. The water content is vaporized from the porous member 13a in moist state, and the vaporized water content passes through the surface layer 15 and released to outside of the cell.

On the other hand, in the porous member 13b having relatively high moisture permeability, the moisture content is easily penetrate through the porous member 13b. Hence, the porous member 13b becomes rich in water-shedding property, so that moisture content in the porous member 13b is held in a low state.

Therefore, among the water contents generated at the cathode catalyst layer 2 when the cell reaction advances, the water content absorbed in the porous member 13a having the low moisture permeability is sequentially evaporated and released to the outside the fuel cell through the surface layer 15.

On the other hand, the water content once absorbed in the porous member 13b having the high moisture permeability is flown back and returned to the anode catalyst layer 3 side. As a result, a water amount required for the reforming reaction of the fuel L at the anode catalyst layer 3 is secured at all times, and there is no case where the water amount is deficient. Accordingly, the cell output can be maintained to be stable and high level at all times. As a result, it was confirmed that the lowering of the cell output characteristics was small and the stable output of the cell could be obtained.

In contrast, in case of the fuel cell according to Comparative Example in which the single-layered moisture retaining plate 13 composed of only the porous member was assembled, it became difficult to control a vaporizing ratio of the moisture content generated from the cathode catalyst layer 2 and a ratio of the moisture content to be flown back to the side of the anode catalyst layer 3. Therefore, there could be confirmed a tendency that the cell output was gradually decreased with advance of operation time due to an influence of an excess amount of water.

Although the present invention has been described with reference to the exemplified embodiments, the present invention is not limited to the described embodiments. In a concretely embodying stage, the present invention can be also embodied by modifying the constitutional elements without departing from the scope or spirit of the present invention. Further, when a plurality of the constitutional elements disclosed in the above embodiments are appropriately combined, various inventions can be embodied. For example, several constitutional elements may be deleted from an entire constitutional elements indicated in the embodiments. In addition, the constitutional elements each constituting different embodiments may be also appropriately combined.

### INDUSTRIAL CAPABILITY

As described above, according to the fuel cell of the present invention, in the porous member having low moisture permeability, the moisture content is hardly penetrated through the porous member. Hence, the porous member becomes rich in moisture retention property, so that the porous member is held in a moist state. The water content is vaporized from the porous member in moist state, and the vaporized water content passes through the surface layer and released to outside of the cell. On the other hand, in the porous member having relatively high moisture permeability, the moisture content is easily penetrate through the porous member. Hence, the porous member becomes rich in water-shedding property, so that moisture content in the porous member is held in a low state. Therefore, among the water contents generated at the cathode catalyst layer when the cell reaction advances, the water content absorbed in the porous member having a low moisture permeability is sequentially evaporated and released to the outside the fuel cell through the surface layer.

On the other hand, the water content once absorbed in the porous member having a high moisture permeability is flown back and returned to the anode catalyst layer side. As a result, a water amount required for the reforming reaction of the fuel at the anode catalyst layer is secured at all times, and there is no case where the water amount is deficient. Accordingly, the cell output can be maintained to be stable and high level at all times.

### BRIEF DESCRIPTION OF THE DRAWINGS

FIG. 1 is a sectional view schematically showing a structure of a first example of a structure of a direct methanol type fuel cell according to the present invention.

FIG. 2 is a sectional view schematically showing a structure of a testing cup used in the moisture permeability testing method (A-1) for measuring the moisture permeability of the moisture retention plate.

FIG. 3 is a sectional view schematically showing a second example of a structure of a direct methanol type fuel cell according to the present invention.

FIG. 4 is a graph showing variations with time in cell voltage of the direct methanol type fuel cells according to Examples 1, 2 and Comparative Example.

FIG. 5 is a sectional view schematically showing a structure of a direct methanol type fuel cell according to Comparative Example in which a single-layered moisture retaining plate 13 is assembled.

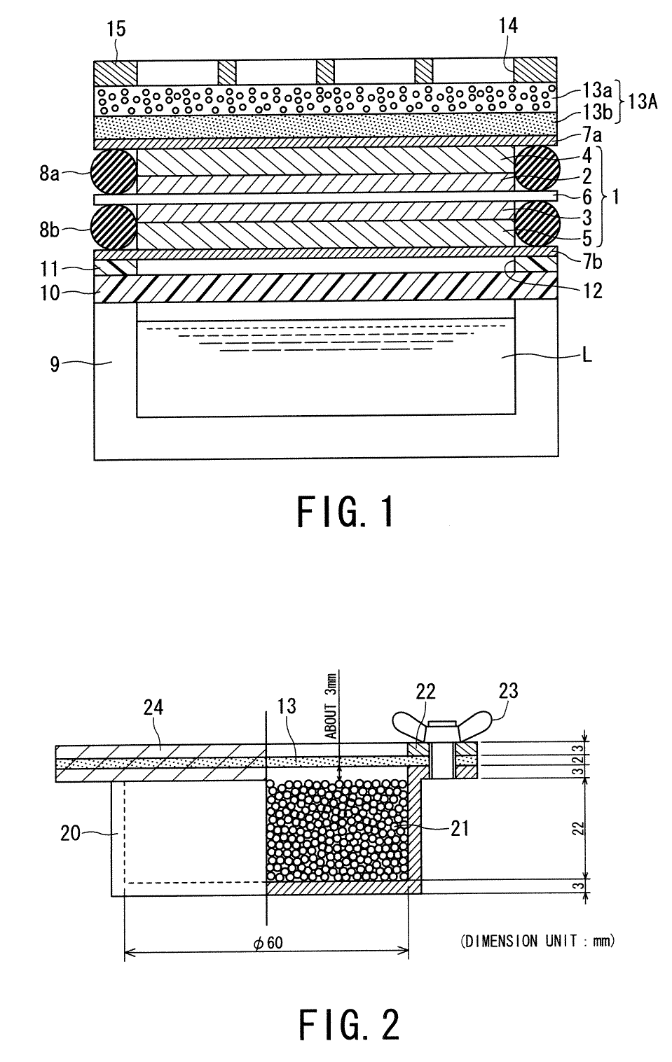

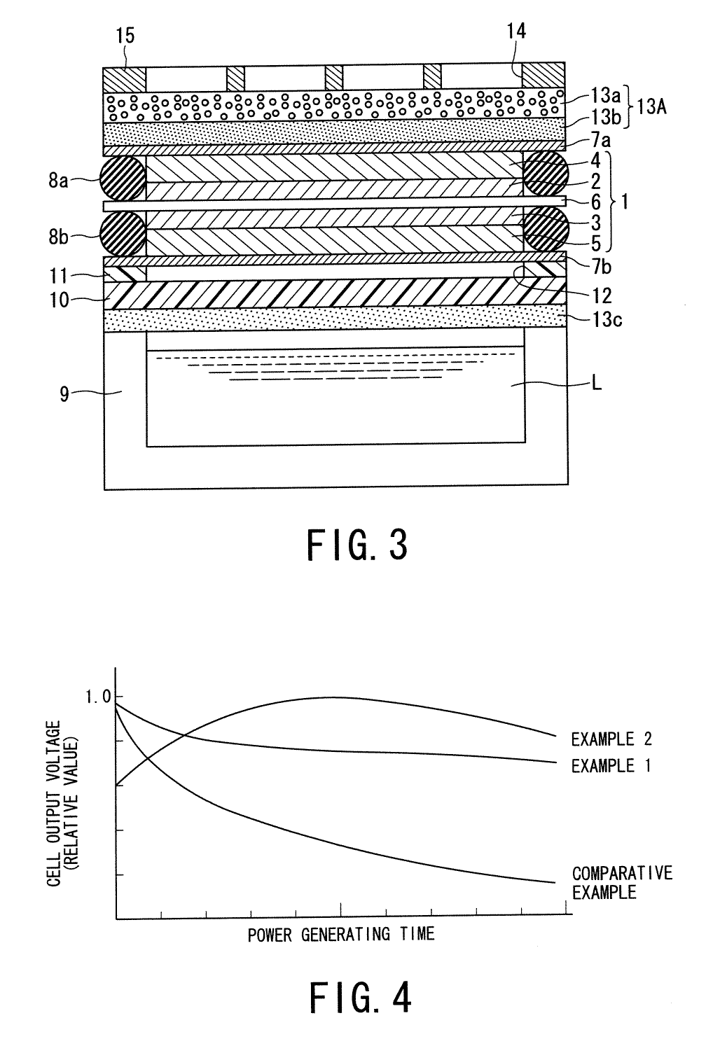

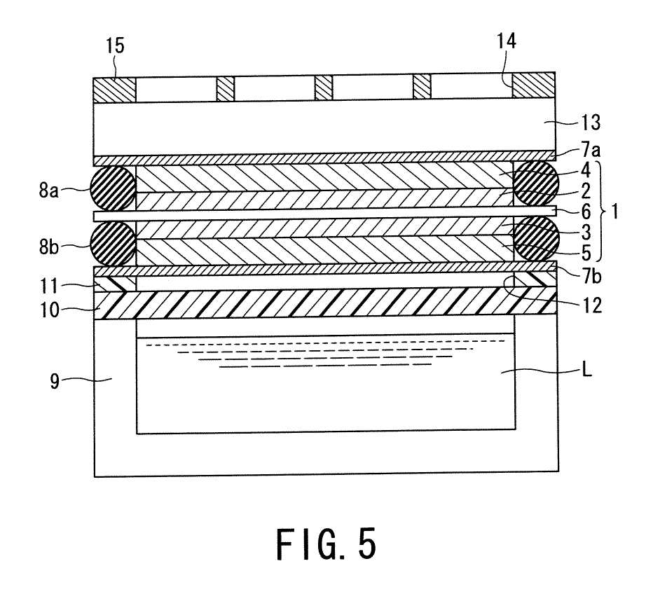

1. A fuel cell comprising:
a cathode catalyst layer;
an anode catalyst layer;
a proton conductive membrane disposed between the cathode catalyst layer and the anode catalyst layer;
a liquid fuel tank for storing a liquid fuel;
a fuel vaporizing layer for supplying a vaporized component of the liquid fuel to the anode catalyst layer;
a surface layer having an air intake port for supplying an air to the cathode catalyst layer; and
a moisture retention plate, disposed between the surface layer and the cathode catalyst layer, for preventing water generated at the cathode catalyst layer from being evaporated,
wherein said moisture retention plate is composed of a laminated body comprising at least two kind of porous members each having different moisture permeability (moisture retention property).

2. The fuel cell according to claim 1, wherein said porous member constituting the moisture retention plate and having a relatively high moisture permeability is disposed to a side of the cathode catalyst layer.

3. The fuel cell according to claim 1 or 2, wherein said porous member constituting the moisture retention plate is a fiber type porous member or a foamed type porous member.

4. The fuel cell according to any one of claims 1 to 3, wherein at least one sheet of porous member is disposed between the liquid fuel tank and the fuel vaporizing layer.

5. The fuel cell according to claim 4, wherein said porous member is a fiber type porous member or a foamed type porous member.
